(19) United States
(12) Patent Application Publication
(10) Pub. No.: US 2011/0054073 A1
(43) Pub. Date: Mar. 3, 2011

(54) CURABLE COMPOSITION AND USE THEREOF

(76) Inventor: Jie Yao, Shanghai (CN)

(21) Appl. No.: 12/942,283

(22) Filed: Nov. 9, 2010

Related U.S. Application Data
(63) Continuation of application No. PCT/CN2008/000939, filed on May 14, 2008.

(51) Int. Cl. C08L 63/00; C08L 39/04; C08K 5/56

(52) U.S. Cl. 523/400; 524/548; 524/398; 524/399; 524/382; 524/381

(57) ABSTRACT

This invention relates to a curable composition comprising one or more of organic metal compounds as resin bleed-out controller and its application in semiconductor packages. Particularly, the organic metal compound is an organic titanate. In some embodiments, the organic titanates include, but are not limited to tetraalkyl titanates and titanate chelates. The composition shows excellent performance in bleeding-out control and thus can reduce the occurrence of failure, such as die top delamination, in semiconductor packages.

### CROSS-REFERENCE TO RELATED APPLICATION

This application is a continuation of International Patent Application Serial No. PCT/CN2008/000939 filed May 14, 2008, the contents of which is incorporated herein by reference.

### FIELD OF THE INVENTION

The present invention generally relates to a curable composition comprising a resin bleed-out controller, and in particular to a curable composition suitable for use in semiconductor packaging.

### BACKGROUND OF THE INVENTION

Compositions comprising resins, fillers, solvents, reactive diluents, or the like, are widely used within the semiconductor packaging industry as adhesives, coatings, and encapsulants. However, in certain applications, these materials exhibit separation of resin part from the composition, known as “bleed-out”, “bleed” or “resin bleed out” (hereinafter RBO), which results in less than optimum performance of the composition.

Currently, a preferred way to control RBO is to add an anti-bleed agent to the formulation, which in most cases is a surfactant. The surfactant usually contains hydrophilic and hydrophobic, or oleophilic and oleophobic, groups at its two molecular ends. This causes the surfactant to migrate to resin-resin, resin-filler, and resin-substrate interfaces. Because the migrated surfactants can not be polymerized during curing of the resin, they are suspected to be the cause of failures that occur in the adhesive, coating, or encapsulant composition used in the fabrication of the semiconductor package.

In recent years, an adhesive composition comprising a fluorine-containing compound as the anti-bleed agent was proposed, for example, see U.S. Pat. No. 4,483,898, issued to Schonborn, et. al. on Nov. 20, 1984.; JP05-331355A; JP07-221126A; and JP2001-11107A. Nevertheless, the lower reactivity of these compounds with bulk resins does not assure correction of RBO.

Therefore, there is still a need in the art for adhesive, coating, and encapsulant compositions with better performance in preventing the bleed-out of resin. The present invention addresses this need.

### SUMMARY OF THE INVENTION

The present invention describes a way to eliminate Resin Bleed-Out (RBO) for adhesive, coating, and encapsulant compositions, particularly die attach adhesives, without using surfactant as an anti-bleed agent by the addition of an organic metal compound, such as an organic titanate, to the composition. The titanate can react both with the resin and the filler in the composition, thereby connecting the two. This improves the compatibility of the system, and allows RBO to be controlled.

In the present invention, a curable composition comprising an organic metal compound as an anti-bleed agent, a method for controlling resin bleed-out in an adhesive composition, the use of the organic metal compound as a resin bleed-out controller, and the article produced by using the adhesive composition are disclosed. Particularly, the present invention includes, but is not limited to, embodiments as follows.
1. A curable composition comprising a resin and a resin bleed-out controller, wherein the resin bleed-out controller comprises an organic metal compound.
2. The curable composition as described in embodiment 1, wherein the organic metal compound is selected from the group consisting of organic titanium compound, organic aluminum compound, organic zirconium compound and combinations thereof.
3. The curable composition as described in embodiment 2, wherein the organic titanium compound comprises an organic titanate and/or titanium chelate.
4. The curable composition as described in embodiment 3, wherein the organic titanate is selected from the group consisting of tetrakis(2-ethylhexyl)titanate, tetraisopropyl titanate, tetra-n-butyl titanate and combination thereof.
5. The curable composition as described in embodiment 3, wherein the titanium chelate is selected from the group consisting of acetylacetonate titanate chelate, ethyl acetoacetate titanate chelate, triethanolamine titanate chelate, lactic acid titanate chelate and combination thereof.
6. The curable composition as described in embodiment 2, wherein the organic aluminum compound comprises distearoyl isopropoxy aluminate.
7. The curable composition as described in embodiment 2, wherein the organic zirconium compound comprises tetraalkyl zirconate, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.
8. The curable composition as described in any one of preceding embodiments, wherein the resin bleed-out controller is present at an amount from about 0.05 wt % to about 20 wt %, based on the total weight of the composition.
9. The curable composition as described in embodiment 8, wherein the resin bleed-out controller is present at an amount from about 0.1 wt % to about 15 wt %, based on the total weight of the composition.
10. The curable composition as described in embodiment 9, wherein the resin bleed-out controller is present at an amount from about 0.5 wt % to about 10 wt %, based on the total weight of the composition.
11. The curable composition as described in embodiment 10, wherein the resin bleed-out controller is present at an amount from about 2 wt % to about 8 wt %, based on the total weight of the composition.
12. The curable composition as described in embodiment 11, wherein the resin bleed-out controller is present at an amount from about 5 wt % to about 8 wt %, based on the total weight of the composition.
13. The curable composition as described in any of preceding embodiments, wherein the resin is selected from one or more of an epoxy, acrylic ester, methacrylic ester, maleimide, vinyl ether, vinyl, cyanate ester, or siloxane resin.
14. The curable composition as described in any one of preceding embodiments further comprises one or more of filler, initiator, and curing agent.
15. The curable composition as described in embodiment 14, wherein the filler is selected from one or more of gold, silver, copper, nickel, iron, alloys of these; copper, nickel, iron, glass, silica, aluminum, or stainless steel coated with gold, silver, or copper; aluminum, stainless steel; silica, glass, silicon carbide, boron nitride, aluminum oxide, boric-acid aluminum, aluminum nitride, oxide filler, and metal coated oxide filler.
16. The curable composition as described in embodiment 14, wherein the curing agent is selected from one or more of Lewis acid, Lewis base, imidazole, anhydride, amine, and amine adduct.
17. The curable composition as described in embodiment 14, wherein the initiator is selected from one or more of peroxide, persulphate, and azo compound.
18. The curable composition as described in any one of embodiments 14-17, wherein the total loading of one or more of the resins falls into the range from about 10-85 wt %, about 20-80 wt %, about 30-70 wt %, or about 40-70 wt %, based on the total weight of the curable composition.
19. The curable composition as described in any one of embodiments 14-17, wherein the total loading of one or more of the fillers is in a range from about 10 wt % to about 85 wt %, about 20 wt % to about 80 wt %, or about 30 wt % to about 70 wt %, based on the total weight of the curable composition.
20. The curable composition as described in any one of embodiments 14-17, wherein the total loading of one or more of the curing agents is in a range from about 0.01 wt % to about 50 wt %, about 0.01 wt % to about 10 wt %, about 0.01 wt % to about 5 wt %, or about 0.1 wt % to about 5 wt %, based on the total weight of the curable composition.
21. The curable composition as described in any one of embodiments 14-17, wherein the total loading of one or more of the radical initiators is present in the range of about 0.01-20 wt %, or about 0.05-5 wt %, based on the total weight of the curable composition.
22. The curable composition as described in any one of preceding embodiments, wherein the curable composition is a die attach curable or an underfill encapsulant.
23. The use of an organic metal compound as a resin bleed-out controller in a curable composition.
24. The use as described in embodiment 23, wherein the organic metal compound is selected from the group consisting of organic titanium compound, organic aluminum compound, organic zirconium compound and combination thereof.
25. The use as described in embodiment 24, wherein the organic titanium compound comprises an organic titanate and/or titanium chelate.
26. The use as described in embodiment 25, wherein the organic titanate is selected from the group consisting of tetrakis(2-ethylhexyl)titanate, tetraisopropyl titanate, tetra-n-butyl titanate and combination thereof.
27. The use as described in embodiment 25, wherein the titanium chelate is selected from the group consisting of acetylacetonate titanate chelate, ethyl acetoacetate titanate chelate, triethanolamine titanate chelate, lactic acid titanate chelate and combination thereof.
28. The use as described in embodiment 24, wherein the organic aluminum compound comprises distearoyl isopropoxy aluminate.
29. The use as described in embodiment 24, wherein the organic zirconium compound comprises tetraalkyl zirconate, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.
30. The use as described in any one of embodiments 23-29, wherein the organic metal compound is present at an amount of from about 0.05 wt % to about 20 wt %, based on the weight of the curable composition.
31. The use as described in embodiment 30, wherein the organic metal compound is present at an amount of from about 0.1 wt % to about 15 wt %, based on the weight of the curable composition.
32. The use as described in embodiment 31, wherein the organic metal compound is present at an amount of from about 0.5 wt % to about 10 wt %, based on the weight of the curable composition.
33. The use as described in embodiment 32, wherein the organic metal compound is present at an amount of from about 2 wt % to about 8 wt %, based on the weight of the curable composition.
34. The use as described in embodiment 33, wherein the organic metal compound is present at an amount of from about 5 wt % to about 8 wt %, based on the weight of the curable composition.
35. A method for controlling resin bleed-out in a curable composition, the method comprising adding an effective amount of a resin bleed-out controller to the curable composition.
36. The method as described in embodiment 35, wherein the resin bleed-out controller comprises one or more of organic metal compounds selected from the group consisting of organic titanium compound, organic aluminum compound, organic zirconium compound and combination thereof.
37. The method as described in embodiment 35 or 36, wherein the total amount of one or more of the organic metal compounds is in the range from about 0.05 wt % to about 20 wt %, preferably from about 0.1 wt % to about 15 wt %, more preferably from about 0.5 wt % to about 10 wt %, still more preferably from about 2 wt % to about 8 wt %, and even more preferably from about 5 wt % to about 8 wt %, based on the total weight of the curable composition.
38. A method for producing an article with a component bonded to a substrate, the method comprising applying the curable composition as described in any one of embodiments 1-22 onto at least a part of the substrate surface and the component, and bonding the component to the substrate surface, and optionally thermally curing the curable composition at a temperature above room temperature after contacting the substrate with the curable composition.
39. An article produced by using the curable composition as described in embodiments 1-22, the article comprising a substrate, a component on the substrate and the curable composition.

Due to the use of organic metal compounds as a resin bleed-out controller in the present invention, which may react both with resin and filler, the compatibility of the adhesive system may be improved and RBO may be controlled. Thus, the adhesive composition of the present invention may show better performance than the prior products in bleeding control and reduce the occurrence of failures, such as die top delamination, in semiconductor packages.

### BRIEF DESCRIPTION OF THE DRAWINGS

FIGS. 1-4 show RBO performances of the adhesive compositions according to the embodiments of the present invention.

### DETAILED DESCRIPTION OF THE INVENTION

Unless defined otherwise herein, all technical and scientific terms used herein have the same meaning as commonly understood by one of ordinary skill in the art to which this invention pertains. Although any methods and materials similar or equivalent to those described herein may find use in the practice of the present invention, the preferred methods and materials are described herein. Accordingly, the terms defined immediately below are more fully described by reference to the Specification as a whole. Also, as used herein, the singular “a”, “an” and “the” includes the plural reference unless the context clearly indicates otherwise. Numeric ranges are inclusive of the numbers defining the range.

### DEFINITION

As used herein, the term “bleed”, “bleed-out” or “resin bleed-out (RBO)” refers to separation of the monomer (oligomer) vehicle phase of resin and filler, as well as the self-bleed or volatile formation of the anti-bleed agent during or after staging or cure, resulting in spread of resin away from the die bond area.

As used herein, the term “an anti-bleed agent” or “resin bleed-out (RBO) controller” means a variety of additives that reduce and/or inhibit, acting alone or in combination, the propensity of monomer (oligomer) vehicle phase of resin and filler to separate.

As used herein, terms such as “resin”, “base”, “filler”, “organic metal compound”, “organic titanate”, “curing agent”, “initiator”, “substrate” and the like are intended to have their commonly accepted meaning in the art to which this invention pertains.

The curable composition may be, but is not limited to, a die attach adhesive or an underfill encapsulant and the like. The article may be, but is not limited to, a semiconductor device.

In an aspect of the present invention, there is provided an adhesive composition comprising at least a resin and a resin bleed-out (RBO) controller.

### Organic Metal Compound

The resin bleed-out controller may comprise an organic metal compound. The organic metal compound may be selected from the group consisting of organic titanium compound, organic aluminum compound, organic zirconium compound and combinations thereof.

In one embodiment, the organic titanium compound is an organic titanate. In some embodiments, the organic titanate is selected from the group consisting of tetraalkyl titanates, and titanate chelates. Tetraalkyl titanates can be represented by the general structure Ti(OR)4, wherein R represents an alkyl group, such as propyl, butyl, isooctyl, or the like. In some embodiments, the tetraalkyl titanates include tetraisopropyl titanate with molecular formula Ti(OC3H7)4; tetra-n-butyl titanate with molecular formula Ti(OC4H9)4; and tetrakis(2-ethylhexyl)titanate with the molecular structure:

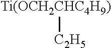

(e.g., Tyzor TOT from DuPont Co.). In other embodiments, the representative tetraalkyl titanates include
isopropyl trioleic titanate,
titanium tris(dodecylbenzenesulfonate)isopropoxide,
titanium tristearoylisopropoxide,
bis(pentane-2,4-dionato-O,O′)bis(alkanolato)titanium,
bis(pentane-2,4-dionato-O,O′)bis(alkanolato)titanium,
bis(pentane-2,4-dionato-O,O′)bis(alkanolato)titanium,
triethanolamine Titanate, diisobutoxy-bis ethylacetoacetato titanate, and
tetrakis(2-ethylhexane-1,3-diolato) titanium.

Titanate chelates that may be used in the present invention may be represented by the formula

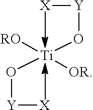

In this molecular structure, X represents a functional group containing oxygen or nitrogen, and Y represents a two- or three-carbon chain. Exemplary titanate chelates include without limitation, TYZOR® AA-series—acetylacetonate titanate chelate,

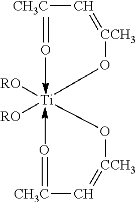

(e.g., Tyzor GBA from DuPont Co.); TYZOR® DC—ethyl acetoacetate titanate chelate

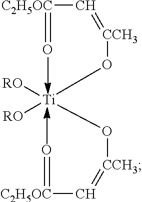

TYZOR® TE, triethanolamine titanate chelate, a mixture of chelates with at least one component that has the following cage structure:

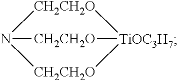

TYZOR® LA—lactic acid titanate chelate, ammonium salt

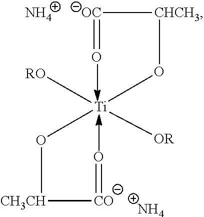

all of which may be commercially available from DuPont.

In some aspects, RBO controller used in the present invention may be an aluminate and/or a zirconate. Exemplary aluminates include without limitation, distearoyl isopropoxy aluminate. Exemplary zirconates include without limitation, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.

Typically, the total loading of one or more of the organic metal compounds will fall into the range from about 0.05 wt % to about 20 wt %, preferably from about 0.1 wt % to about 15 wt %, more preferably from about 0.5 wt % to about 10 wt %, still more preferably from about 2 wt % to about 8 wt %, and even more preferably from about 5 wt % to about 8 wt %, based on the total weight of the adhesive composition. In one aspect, the total loading of the organic metal compounds may be 0.5 wt %, 1 wt %, 4 wt % or 8 wt % by weight of the adhesive composition.

### Resin

The resin used in the present invention may be any resin, including without limitation, one or more epoxy, acrylic ester, methacrylic ester, maleimide, vinyl ether, vinyl, cyanate ester, or siloxane resin and the like.

Exemplary epoxy resins include, for example, those selected from such as, liquid epoxy, liquid epoxy combination with different kinds of liquid epoxy, and solid epoxy in solution. The epoxy may also have additional functionality, for example, such as those substituted with amine or hydroxyl groups. The epoxy may also be unsubstituted, such as, 1,2-epoxypropane, 1,3-epoxypropane, butylene oxide, n-hexyl propylene epoxide or the like. Examples of commercially available epoxy resin include Epon™ Resin 862, Epiclon N-730A, Epiclon 830S (Resolution Performance Products, P.O. Box 4500, Houston, Tex. 77210,USA.); D.E.R.TM332 (The Dow Chemical Company, Midland, Mich. 48674); Araldite GY285 (Chemica Inc. 316 West 130th Street, Los Angeles, Calif., 90061, USA); RSL-1739 (P Bisphenol F/epichlorohydrin epoxy resin, from Resolution Performance Products); and NSC Epoxy 5320 (1,4-butanedioldiglycidyl ether, from Henkel Corporation.

Exemplary acrylic ester or methacrylic ester compounds include but are not limited to, liquid (meth)acrylate, liquid (meth)acrylates combination with, different kinds of acrylates and solid (meth)acrylate (monomer or oligomer) in solution. Specific examples include methyl acrylate, ethyl acrylate, propylacrylate, isopropyl acrylate, n-butyl acrylate, isobutyl acrylate, t-butyl acrylate, amyl acrylate, isoamyl acrylate, hexyl acrylate, heptyl acrylate, octyl acrylate, 2-ethylhexyl acrylate, nonyl acrylate, decyl acrylate, isodecyl acrylate, laurylacrylate, tridecyl acrylate, hexadecyl acrylate, stearylacrylate, isostearyl acrylate, cyclohexyl acrylate, isobornyl acrylate, 2-hydroxyethyl acrylate, 2-hydroxypropyl acrylate, 2-hydroxy butyl acrylate, 4-hydroxy butyl acrylate, diethylene-glycol acrylate, polyethylene-glycol acrylate, polypropylene-glycol acrylate, 2-methoxy ethyl acrylate, 2-ethoxyethyl acrylate, 2-butoxy ethyl acrylate, methoxy diethylene-glycol acrylate, methoxy polyethylene-glycol acrylate, 2-phenoxy ethyl acrylate, methyl methacrylate, ethyl methacrylate, propyl methacrylate, isopropyl methacrylate, n-butyl methacrylate, isobutyl methacrylate, t-butyl methacrylate, amyl methacrylate, isoamyl methacrylate, hexyl methacrylate, heptyl methacrylate, octyl methacrylate, 2-ethylhexyl methacrylate, nonyl methacrylate, isodecyl methacrylate, lauryl methacrylate, tridecyl methacrylate, hexadecyl methacrylate, stearyl methacrylate, isostearyl methacrylate, cyclohexyl methacrylate, isobornyl methacrylate, 2-hydroxyethyl methacrylate, 2-hydroxypropyl methacrylate, 2-hydroxy butyl methacrylate, 4-hydroxy butyl methacrylate, dimer diol mono-methacrylate, diethylene-glycol methacrylate, polyethylene-glycol methacrylate, polypropylene-glycol methacrylate, 2-methoxy ethyl methacrylate, 2-ethoxyethyl methacrylate, 2-butoxyethylmethacrylate, methoxy diethylene-glycol methacrylate, methoxy polyethylene-glycol methacrylate, 2-phenoxy ethyl methacrylate, phenoxy diethylene-glycol methacrylate, phenoxy polyethylene-glycol methacrylate, 2-benzoyloxy ethyl methacrylate, and 2-hydroxy-3-phenoxy propyl methacrylate.

Examples of commercially available acrylic ester or methacrylic ester compound include SR506 (isobornyl acrylate), SR9020 (propoxylated glyceryl triacrylate) (Sartomer Inc. (Shanghai), 500 Fu Te 2nd East Road, Wai Gao Qiao Free Trade Zone, Shanghai, 200131), SR368 (tris(2-hydroxy ethyl) isocyanurate triacrylate, from Sartomer), CN120Z (epoxy acrylate, from Sartomer) and SR306 (tripropylene glycol diacrylate, from Sartomer).

Exemplary cyanate ester resins used in the present invention include various suitable cyanate esters known in the art, for example, ethylene diisocyanate; 1,4-tetramethylene diisocyanate; 1,4 and/or 1,6-hexamethylene diisocyanate; 1,12-dodecane diisocyanate; cyclobutane-1,3-diisocyanate; cyclohexane-1,3- and 1,4-diisocyanate and mixtures of these isomers; 1-isocyanato-3,3,5-trimethyl-5-isocyanatomethyl cyclohexane; 2,4- and 2,6-hexahydrotolylene diisocyanate and mixtures of these isomers; hexahydro-1.,3- and/or 1,4-phenylene diisocyanate; perhydro-2,4′- and/or 4,4′-diphenyl methane diisocyanate; 1,3- and 1,4-phenylene diisocyanate; 2,4- and 2,6-toluene diisocyanate and mixtures of these isomers; diphenyl methane-2,4′- and/or 4,4′-diisocyanate; naphthylene-1,5-diisocyanate; 1,3- and 1,4-xylylene diisocyanate, 4,4′-methylene-bis(cyclohexyl isocyanate), 4,4′-isopropyl-bis(cyclohexyl isocyanate), 1,4-cyclohexyl diisocyanate and 3-isocyanatomethyl-3,5,5-trimethylcyclohexyl isocyanate (IPDI); 2,4- and 2,6-toluene diisocyanate; diphenylmethane diisocyanate; hexamethylene diisocyanate; dicyclohexylmethane diisocyanate; isophorone diisocyanate; 1-methyoxy-2,4-phenylene diisocyanate; 1-chlorophenyl-2,4-diisocyanate; p-(1-isocyanatoethyl)-phenyl isocyanate; m-(3-isocyanatobutyl)-phenyl isocyanate and 4-(2-isocyanate-cyclohexyl-methyl)-phenyl isocyanate, isophorone diisocyanate, toluene diisocyanate and mixtures thereof.

Exemplary siloxane resins include non-functional silanes and functionalized silanes, including amino-functional, epoxy-functional, acrylate-functional and other functional silanes, which are known in the art, for example r-glycidoxypropyl-trimethoxysilane, γ-glycidoxypropyltriethoxysilane, glycidoxypropyltriethoxysilane, r-glycidoxypropyl-methyldiethoxysilane, glycidoxypropyltrimethoxysilane, glycidoxypropylmethyldimethoxysilane, glycidoxypropylmethyldiethoxysilane, 5,6-epoxyhexyltriethoxysilane, epoxycyclohexylethyltrimethoxysilane, trimethoxysilylpropyldiethylene-triamine, N-methylaminopropyltrimethoxysilane, aminoethylaminopropylmethyldimethoxysilane, aminoethylaminopropyltrimethoxysilane, aminopropylmethyldimethoxysilane, aminopropyltrimethoxysilane, aminoethylaminoethylaminopropyl-trimethoxysilane, N-methylamino-propyltrimethoxysilane, methylamino-propyltrimethoxysilane, aminopropylmethyl-diethoxysilane, aminopropyltriethoxysilane, 4-aminobutyltriethoxysilane, oligomeric amino alkylsilane, m-aminophenyltrimethoxysilane, phenylaminopropyltrimethoxysilane, aminoethylaminopropyltriethoxysilane, aminoethylaminoisobutylmethyldimethoxysilane, (3-acryloxypropyl)-trimethoxysilane, gamma-methacryloxypropyltrimethoxysilane, gamma-mercapto-propyltriethoxysilane, and olefinic silanes, such as vinyltrialkoxysilane, vinyltriacetoxysilane, alkylvinyldialkoxysilane, allyltrialkoxysilane, hexenyltrialkoxysilane and the like.

Other resins may also be used in the present invention, for example, Epiclon EXA-830CRP (epichlorohydrin phenolformaldehyde resin, from Dinippon Ink & Chemicals Inc.), SRM-1 (C36 branched alkane diyl bis-[6-(2,5-dihydro-2,5-dioxo-1H-pyrol-1-yl)hexanoate], from Henkel Corporation), and the like.

Typically, the total loading of one or more of the resins may fall into the range from about 10-85 wt %, preferably about 20-80 wt %, more preferably about 30-70 wt %, and more preferably about 40-70 wt %, based on the total weight of the adhesive composition.

### Filler

The adhesive composition may further comprise filler. The fillers used in the practice of the present invention may include, but are not limited to organic and inorganic filler, electrical conductive or insulative as needed, such as gold, silver, copper, nickel, iron, alloys of these; copper, nickel, iron, glass, silica, aluminum, or stainless steel coated with gold, silver, or copper; aluminum, stainless steel; silica, glass, silicon carbide, boron nitride, aluminum oxide, boric-acid aluminum, aluminum nitride, oxide filler, and metal coated oxide filler and the like. Specific examples of commercially available fillers includes Cab-O-Sil® TS-720 silica (from Silicon Dioxide), SP-10G silica (amorphous silica, from Fuso Chemical Co., Ltd.), SE-1 (silicon dioxide, amorphous, hexamethyldisilazane treated, from Gelest), etc.

Typically, the total loading of one or more of the fillers may be in a range from about 10 wt % to about 85 wt %, and preferably from about 20 wt % to about 80 wt %, or from about 30 wt % to about 70 wt %, based on the total weight of the adhesive composition.

### Curing Agent

The adhesive composition may further comprise a curing agent. The curing agent used in the practice of the present invention may include, for example, Lewis acid, Lewis base, imidazole, anhydride, amine, amine adduct or the like, for example, 1-cyanoethyl-2-phenylimidazole, 2-phenylimidazole, 2-methylimidazole, 2-phenylimidazoline, 1-cyanoethyl-2-phenylimidazolium-trimellitate. Specific examples of curing agents may include Jeffamine D-2000 (polyoxypropylene diamine, from Huntsman Petrochemical Corporation), 2P4MZ (micronized to 10 microns, phenylmethylimidazole, from National Starch & Chemicals), EMI-24-CN (1-(2-cyanoethyl)-2-ethyl-4-methylimidazole, from Borregaad Synthesis), etc.

Typically, if present, the total loading of one or more of the curing agents may be in a range from about 0.01 wt % to about 50 wt %, preferably from about 0.01 wt % to about 10 wt %, and more preferably from about 0.01 wt % to about 5 wt %, or from about 0.1 wt % to about 5 wt %, based on the total weight of the adhesive composition.

### Initiator

The radical initiator used in the practice of the present invention may include, but is not limited to peroxide, persulphate, azo compound and their combination. The preferred radical initiator may include peroxide, such as methyl ethyl ketone peroxides, tertiary-amyl peroxy-2-ethylhexyl carbonate, tertiary-butyl peroxyacetate, dicumyl peroxide and so on. Specific examples of initiators may be, for example, PERKADOX 16 (di(4-tert-butylcyclohexyl)peroxydicarbonate) and Trigonox 21S (tert-butyl peroxy-2-ethylhexanoate), both of which are commercially available from Akzo Nobel).

Typically, if present, the total loading of one or more of the radical initiators may be present in the range of about 0.01-20 wt %, preferably from about 0.05-5 wt %, based on the total weight of the curable composition.

In another aspect of the present invention, there is provided a method for controlling the resin bleed-out in a curable composition, said method comprising adding an effective amount of the resin bleed-out controller to the curable composition. As described above, the resin bleed-out controller may comprise an organic metal compound. The organic metal compound may be selected from the group consisting of organic titanium compound, organic aluminum compound, organic zirconium compound and combinations thereof. The total amount of one or more of the organic metal compounds may in the range from about 0.05 wt % to about 20 wt %, preferably from about 0.1 wt % to about 15 wt %, more preferably from about 0.5 wt % to about 10 wt %, still more preferably from about 2 wt % to about 8 wt %, and even more preferably from about 5 wt % to about 8 wt %, based on the total weight of the curable composition. In one aspect, the total amount of one or more of the organic metal compounds may be 0.5 wt %, 1 wt %, 4 wt % or 8 wt % by weight of the curable composition.

In yet another aspect of the present invention, the present invention further provides a method for producing an article with a component bonded to a substrate, the method comprising applying the above-described curable composition onto at least a part of the substrate surface and the component, and bonding the component to the substrate surface. In some embodiments, the method further comprises a step of thermally curing the adhesive at a temperature above room temperature, the step being performed after contacting the substrate with the adhesive. In still another aspect, the component bonded to a substrate may be a semiconductor component, such as a die.

In another aspect of the present invention, there is provided an article produced by the above-described method, the article comprising a substrate, a component on the substrate and the said curable composition by which the component bonded to the substrate. The said component may be a semiconductor component. The said substrate may be selected from Ag/Cu, bare copper, Ni/Pd/Au substrate, NiP substrate, FR4 substrate or the like. NiP stands for Nickel Phosphorus; FR4 is a code for a type of Epoxy glass substrate.

In a further aspect of the present invention, there is provided the use of the organic metal compound as resin bleed-out controller in a curable composition, for example, die attach adhesive, underfill, etc. As described above, the organic metal compound may be selected from the group consisting of organic titanium compound, organic aluminum compound, organic zirconium compound and combinations thereof. The total amount of one or more of the organic metal compounds may in the range from about 0.05 wt % to about 20 wt %, preferably from about 0.1 wt % to about 15 wt %, more preferably from about 0.5 wt % to about 10 wt %, still more preferably from about 2 wt % to about 8 wt %, and even more preferably from about 5 wt % to about 8 wt %, based on the total weight of the curable composition. In one aspect, the total amount of one or more of the organic metal compounds may be 0.5 wt %, 1 wt %, 4 wt % or 8 wt % by weight of the curable composition.

The invention will now be further described with reference to the following non-limiting examples.

### EXAMPLES

### RBO Test Procedure

In order to test for the limitation of resin bleed out, a RBO test was performed following the instruction:

Dispense a small dot of the adhesive composition on the substrate surface, using EFD hand dispenser (From EFD Inc., a Nordson Company, 977 Waterman Avenue, East Province, R.I. 02914-1342 USA);

Measure the diameter (A) of the adhesive dot immediately under microscope;

Expose the substrate to ambient conditions for two hours;

Measure the diameter (B) of the bleed that surrounds the adhesive under microscope;

Heat sample to let it cure, measure RBO again.

Once all data measured, calculate RBO using the equation:

RBO(%)=(B−A)×100/A.

### Example 1

### Preparation of the Adhesive Composition

Two groups of formulations are shown in Table 1 (Group 1 for examples 1-3) and Table 2 (Group 2 for examples 4-7), based on epoxy resin and BMI(bismaleimide)/acrylate hybrid resin, respectively.

For epoxy based formulations, add all raw materials in a jar following the sequence listed in Table 1. For example, weighing 2.807 g RSL-1739, 0.2 g Jeffamine D-2000, 0.108 g Cab-O-Sil TS-720 silica, 0.2 g 2P4MZ, 5 g SP-10G silica, 0.913 g NSC EPDXY 5320, and 0.05 g EMI-24-CN, 9.278 g Exp1 sample is obtained. Hand mix the compound in fume hood for 5 minutes, use spatula to guide the materials flow, and pay attention to jar corners, jar walls to mix well. Then let the material go through twice three-roll milling with in feed gap 2 mil, out feed gap 1.5 mil. The three roll mill used was EXAKT 50 from EXAKT Apparatebau GmBH & Co.kG, Robert-Koch-Strasse 5, 22851 Norderstedt, Germany. Hand mix for 5 minutes until a homogenous mixture is obtained.

For BMI/acrylate hybrid based formulations, add all raw materials in a jar following the sequence listed in Table 2. For example, weighting 1.672 g SRM-1, 0.891 g SR368, 1.3263 g CN120Z, 1.36 g SR306, 0.0375 g PERKADOX 16, 0.1125 g Trigonox 21S, 3.08 g SE-1, 1.52 g SP-10G, 0.1 g tetrakis(2-ethylhexyl) titanate (Tyzor TOT), and 0.4 g acetylacetonate titanate chelate (Tyzor GBA), 10.5 g Exp7 sample will be obtained. Hand mix the compound in fume hood for 5 minutes, use spatula to guide the materials flow, and pay attention to jar corners, jar walls to mix well. Then let the material go through twice three-roll milling with in feed gap 2 mil, out feed gap 1.5 mil. Hand mix for 5 minutes until a homogenous mixture is obtained.

TABLE 1
Epoxy Based Formulations

| Name of raw material | Exp1 | Exp2 | Exp3 |
|---|---|---|---|
| Test viehcle | TV1 | TV1 | TV2 |
| RSL-1739 | 28.07 | 28.07 | |
| Epiclon EXA-830CRP | | | 36 |
| Jeffamine D-2000 | 2 | 2 | 3 |
| Cab-O-Sil TS-720 silica | 1.08 | 1.08 | |
| 2P4MZ, Micronized to 10 | 2 | 2 | 2 |
| Microns | | | |
| SP-10G silica | 50 | 50 | 51 |
| NSC Epoxy 5320 | 9.13 | 9.13 | 6 |
| EMI-24-CN | 0.5 | 0.5 | |
| Tyzor GBA | | 4 | 8 |
| Sum | 92.78 | 96.78 | 106 |

TV: test vehicle

TABLE 2
BMI/Acrylate Hybrid Based Formulations

| Name of raw material | Exp4 | Exp5 | Exp6 | Exp7 |
|---|---|---|---|---|
| Test viehcle | TV3 | TV3 | TV3 | TV3 |
| SRM-1 | 16.72 | 16.72 | 16.72 | 16.72 |
| SR368 | 8.91 | 8.91 | 8.91 | 8.91 |
| CN120Z | 13.263 | 13.263 | 13.263 | 13.263 |
| SR306 | 13.6 | 13.6 | 13.6 | 13.6 |
| PERKADOX 16 | 0.375 | 0.375 | 0.375 | 0.375 |
| Trigonox 21S | 1.125 | 1.125 | 1.125 | 1.125 |
| SE-1 | 30.8 | 30.8 | 30.8 | 30.8 |
| SP-10G | 15.2 | 15.2 | 15.2 | 15.2 |
| Tyzor TOT | | 0.5 | | 1 |
| Tyzor GBA | | | 0.5 | 4 |
| Sum | 99.997 | 100.497 | 100.497 | 104.997 |

### RBO Performance of the Adhesive Compositions

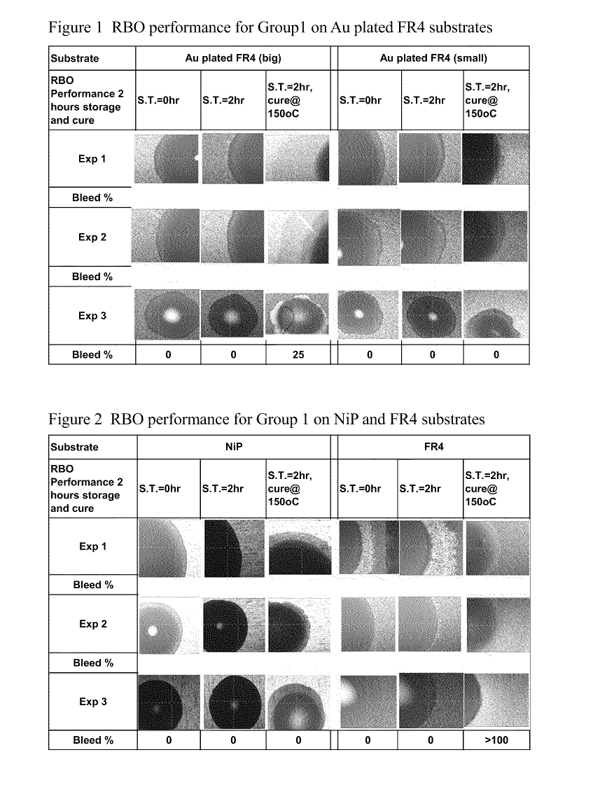

RBO performances of the adhesive compositions in two Groups on a substrate are showed in FIGS. 1-4 (all percentages in tables represent RBO % as measured using the procedure described above).

As can be seen in FIG. 1, bleed performance on Au plated FR4 got improved with increase of organic titanates content. Particularly, on big Au plated FR4 substrate, Bleed % after cure reduced by 31% (from 93% to 64%) when 4 wt. % of acetylacetonate titanate chelate (Tyzor GBA) was added, and further reduced by 73% (from 93% to 25%) when 8 wt. % of acetylacetonate titanate chelate (Tyzor GBA) was added. In the case of small Au plated FR4 substrate, Bleed % after cure was reduced from 10% to 0% no matter 4 wt. % or 8 wt. % of acetylacetonate titanate chelate (Tyzor GBA) was added.

In FIG. 2, on NiP substrate, Bleed % after cure was reduced from 19% to 0% whether 4 wt. % or 8 wt. % of acetylacetonate titanate chelate (Tyzor GBA) was added. For FR4 substrate, bleed after 2 hours storage time was significantly reduced by 89.6% (from 77% to 8%) when 4 wt. % of acetylacetonate titanate chelate (Tyzor GBA) was added, and further reduced to 0% when 8 wt. % of acetylacetonate titanate chelate (Tyzor GBA) was added.

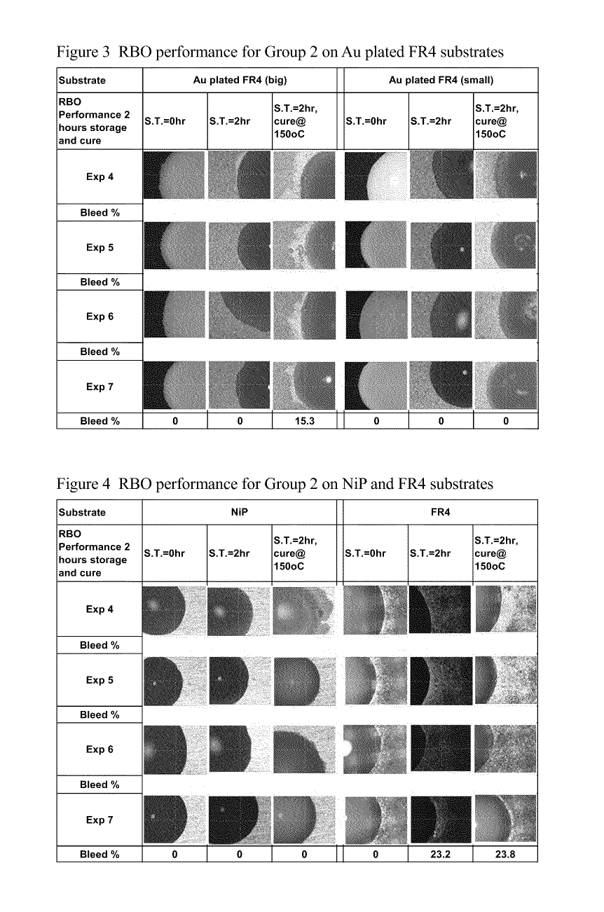

In FIG. 3, it can be seen that for Group 2 examples, bleed on big Au plated FR4 was reduced significantly with increase of amount of tetrakis(2-ethylhexyl) titanate (Tyzor TOT) and acetylacetonate titanate chelate (Tyzor GBA), especially for bleed after 2 hours storage time. On small Au plated FR4 substrate, bleed was not observed with sample that does not contain Tyzor, and with addition of Tyzor TOT or/and GBA, RBO was still not observed, showing that Tyzor does not bring new RBO on the substrate that originally has no RBO.

In FIG. 4, it can be seen that for Group 2 examples, bleed on NiP and FR4 substrates was reduced significantly with increase of amount of tetrakis(2-ethylhexyl) titanate and acetylacetonate titanate chelate, for example, Bleed % after cure on NiP was reduced from 29.9% to 0% with addition of tetrakis(2-ethylhexyl) titanate or/and acetylacetonate titanate chelate. Bleed % after cure on FR4 was reduced by 61% with 0.5 wt % of tetrakis(2-ethylhexyl) titanate added, further reduced by 64% with 0.5 wt % of acetylacetonate titanate chelate added, and furthermore, reduced by 89% with 1 wt % tetrakis(2-ethylhexyl) titanate and 4 wt % acetylacetonate titanate chelate added.

In summary, resin bleed out can be reduced with addition of tetrakis(2-ethylhexyl) titanate/acetylacetonate titanate chelate, and the effect get stronger with increase of amount of Tyzor, especially after cure. Tetrakis(2-ethylhexyl) titanate/acetylacetonate titanate chelate will also not bring bleed out issue for formulations that do not have this issue in nature.

### Example 2

### Effect of the Amount of the Organic Metal Compound on RBO Performance of the Adhesive Compositions

The effect of the amount of the organic metal compound on bleeding control performance of the adhesive composition is shown in Table 3. As can be seen in Table 3, the bleeding control effect is increased as the amount of the organic metal compound is increased.

TABLE 3
The effect of the amount of the organic metal compound
on the performance of the adhesive composition

| Oven cure | Exp1 | Exp2 | Exp3 |
|---|---|---|---|
| TV1 | 92.78 | 92.78 | / |
| TV2 | / | / | 98 |
| Tyzor GBA | / | 4 | 8 |
| Total | 92.78 | 96.78 | 106 |
| Bleed % on Au plated FR4(big) | 93 | 64 | 25 |
| Bleed % on Au plated FR4(small) | 10 | 0 | 0 |
| Bleed % on NiP | 19 | 0 | 0 |
| Bleed % on FR4 | >100 | >100 | >100 |

| Oven cure | Exp4 | Exp5 | Exp6 | Exp7 |
|---|---|---|---|---|
| TV3 | 99.997 | 99.997 | 99.997 | 99.997 |
| Tyzor TOT | / | 0.5 | / | 1 |
| Tyzor GBA | / | / | 0.5 | 4 |
| Total | 99.997 | 100.497 | 100.497 | 104.997 |
| Bleed % on Au plated FR4(big) | 39.5 | 27.9 | 10.3 | 15.3 |
| Bleed % on Au plated FR4(small) | 0 | 0 | 0 | 0 |
| Bleed % on NiP | 29.9 | 0 | 0 | 0 |
| Bleed % on FR4 | 213.2 | 83.5 | 76.5 | 23.8 |

### Example 3

### The Application of the Adhesive Composition for Die Attach

This example shows an article or a process of producing the article, the article comprising a semiconductor component bonded to a substrate by one of the resultant adhesive compositions prepared in the Example 1.

At least a part of the substrate surface is applied with the adhesive composition Exp2 in Table 1 in a coating thickness of 1-2 mm, and then a die is applied to the adhesive-coated substrate surface. The die is bonded to the substrate after the adhesive is cured at a temperature, for example, 120° C. for 20 minutes, 110° C. for 10 minutes, 150° C. for 30 minutes, and 180° C. for 50 minutes and so on.

Those skilled in the art readily appreciate that the present invention is well adapted to achieve the purposes and obtain the advantages mentioned, as well as those inherent herein. It will be readily apparent to one skilled in the art that varying substitutions and modifications may be made to the invention disclosed herein without departing from the scope and spirit of the invention.

What is claimed:

1. A curable composition comprising a resin and a resin bleed-out controller, wherein the resin bleed-out controller comprises an organic metal compound.

2. The curable composition as claimed in claim 1, wherein the organic metal compound is selected from the group consisting of organic titanium compound, organic aluminum compound, organic zirconium compound and combinations thereof.

3. The curable composition as claimed in claim 2, wherein the organic titanium compound is selected from the group consisting of tetrakis(2-ethylhexyl)titanate, tetraisopropyl titanate, tetra-n-butyl titanate, acetylacetonate titanate chelate, ethyl acetoacetate titanate chelate, triethanolamine titanate chelate, lactic acid titanate chelate and combinations thereof.

4. The curable composition as claimed in claim 2, wherein the organic aluminum compound comprises distearoyl isopropoxy aluminate.

5. The curable composition as claimed in claim 2, wherein the organic zirconium compound comprises tetraalkyl zirconate, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.

6. The curable composition of claim 1, wherein the resin bleed-out controller is present at an amount of from about 0.05 wt % to about 20 wt %, based on the total weight of the curable composition.

7. The curable composition of claim 1, wherein the resin is selected from one or more of an epoxy, acrylic ester, methacrylic ester, maleimide, vinyl ether, vinyl, cyanate ester, or siloxane resin.
